(19) United States
(12) Patent Application Publication
(10) Pub. No.: US 2026/0210675 A1
(43) Pub. Date: Jul. 23, 2026

(54) SWITCH FOR FIREARM-MOUNTED LIGHT

(71) Applicant: Coast Cutlery Co., Portland, OR (US)

(72) Inventors: David Goldman, Portland, OR (US); Chi Him Wong, Kowloon (HK)

(21) Appl. No.: 19/440,519

(22) Filed: Jan. 5, 2026

Related U.S. Application Data
(60) Provisional application No. 63/747,275, filed on Jan. 20, 2025.

(51) Int. Cl. F41G 11/00; F41C 27/00; H01H 13/04; H01H 13/14; H01H 13/52

(52) U.S. Cl. CPC F41G 11/003; F41C 27/00; H01H 13/04; H01H 13/14; H01H 13/52; H01H 2013/525

(57) ABSTRACT

Embodiments disclosed herein include a switch for a firearm-mounted light. A firearm-mounted accessory includes a body including clamping members to mount to a rail of a firearm, a tail cap attached to a rear side of the body, left-side and right-side axles held rotatably in the tail cap, left-side and right-side outer arms attached to the left-side and right-side axles, respectively, left-side and right-side inner arms within the tail cap and attached to the left-side and right-side axles, respectively, a printed circuit board (PCB) held in the tail cap, and left-side and right-side button switches coupled to the PCB, wherein when the left-side and right-side outer arms are pressed, the left-side and right-side inner arms are configured to rotate to a position in which they press the left-side and right-side button switches, respectively.

### PRIORITY CLAIM

This application claims the benefit of U.S. provisional patent application No. 63/747,275, filed Jan. 20, 2025, titled “Switch For Firearm-Mounted Light,” which is incorporated herein by reference.

### TECHNICAL FIELD

Embodiments herein relate to a switch for a type of firearm-mounted light that is particularly suited for mounting to a rail of a firearm.

### BACKGROUND

Many firearms such as handguns have an integrated rail, e.g., a Picatinny or Weaver style rail, to allow mounting of accessories such as a light. The accessory can be mounted under a barrel of the handgun, for instance. A firearm-mounted light is useful in many situations such as for home defense to allow identification of a threat in a low light scenario. However, various challenges are encountered in designing such lights.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A depicts a side-rear view of a firearm-mounted light 100, including a light body 1, an optic 110 at the front of the main body, and a tail section 120 at the rear of the light body, in accordance with various embodiments.

FIG. 1B depicts an example block diagram of circuitry of the firearm-mounted light 100, in accordance with various embodiments.

FIG. 2 depicts a cutaway cross-sectional view of the tail section 120 and a portion 1a of the body 1 of the firearm-mounted light 100 of FIG. 1A, in accordance with various embodiments.

FIG. 3A depicts an exploded view of the firearm-mounted light 100 of FIG. 1A, in accordance with various embodiments.

FIG. 3B depicts a front side of the button printed circuit board (PCB) 7 of FIG. 3A, in accordance with various embodiments.

FIG. 4A depicts a cutaway view of a portion of a switch assembly 400 in the tail section 120 of the firearm-mounted light 100 of FIG. 1A, including the left-side outer arm 3, in accordance with various embodiments.

FIG. 4B depicts an exploded side-rear view of a portion of the switch assembly 400 of FIG. 4A with the right-side outer arm 4, in accordance with various embodiments.

FIG. 4C depicts a collapsed view of the portion of the switch assembly 400 of FIG. 4B, in accordance with various embodiments.

FIG. 4D depicts an exploded side-front view of a portion of the switch assembly 400 of FIG. 4A with the right-side outer arm 4, in accordance with various embodiments.

FIG. 4E depicts a collapsed view of the portion of the switch assembly 400 of FIG. 4D, in accordance with various embodiments.

FIG. 5 depicts a cross-sectional view of an embodiment of the firearm-mounted light 100 of FIG. 1A in which an axle 31 and a button switch 30 of the switch assembly are both on one side of a centerline 510 of the light, in accordance with various embodiments.

FIG. 6 depicts a cross-sectional view of an embodiment of the firearm-mounted light 100 of FIG. 1A in which an axle 31 is sitting in-line with the centerline 610 of the battery 520 but below the centerline 620 of the light.

FIG. 7 depicts a top cutaway view of the switch assembly of the firearm-mounted light 100 of FIG. 1A, in accordance with various embodiments.

FIG. 8 depicts a rearward-facing cutaway view of the tail section 120 of the firearm-mounted light 100 of FIG. 1A, in accordance with various embodiments.

FIG. 9A depicts a side view of the firearm-mounted light 100 of FIG. 1A attached to an example firearm 900, in accordance with various embodiments.

FIG. 9B depicts a closeup side-rear view of the firearm 900 and firearm-mounted light 100 of FIG. 9A, in accordance with various embodiments.

FIG. 9C depicts a closeup side-bottom view of the switch arm 3 and the trigger guard 910 of the firearm 900, in accordance with various embodiments.

FIG. 10 depicts a cutaway view of a portion of another switch assembly 1000 in a tail section of a firearm-mounted light, including a right-side outer arm 1005R, and left-side and right-side inner arms 1060L and 1060R, respectively, in accordance with various embodiments.

FIG. 11 depicts a side view of the switch assembly 1000, including the right-side outer arm 1005R, within a tail cap 1002, in accordance with various embodiments.

FIG. 12 depicts a side view of the switch assembly 1000, including the left-side outer arm 1005L, in accordance with various embodiments.

FIG. 13 depicts a view of the switch assembly 1000, including further detail of the left-side and right-side inner arms 1060L and 1060R, respectively, in accordance with various embodiments.

FIG. 14 depicts a view of the switch assembly 1000, including the left-side and right-side outer arms 1005L and 1005R, respectively, in accordance with various embodiments.

FIG. 15 depicts an exploded top-rear view of the switch assembly 1000, in accordance with various embodiments.

FIG. 16 depicts an exploded top-front view of the switch assembly 1000, in accordance with various embodiments.

FIG. 17 depicts an exploded top view of the switch assembly 1000, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

As mentioned at the outset, various challenges are presented in designing a firearm-mounted light.

A firearm may include a rail that is used to secure an accessory such as a light. The rail can be provided according to a standard such as MIL-STD-1913 which is also known as a Picatinny rail in reference to the Picatinny Arsenal of the U.S. Army in New Jersey, or according to a manufacturer-specific design.

The light can be mounted below the barrel and in front of the trigger guard of a handgun/pistol, in one approach. The light could include a light source such as an incandescent light, a light-emitting diode (LED), or a laser, for example. Other accessories such as a camera, night-vision device, or range-finder could also be provided.

A switching assembly of the light should provide a number of features. For example, it is desirable for the switching assembly to allow for ambidextrous pointer finger control. It is also desirable for the switching assembly to provide a reliable switching action. In some cases, it is desirable for a switching assembly to activate different modes of the light, such as a high or low output mode, or a strobe mode. The switching assembly should also be easy to manufacture and cost-effective.

The solutions provided herein address the above and other issues.

In one aspect, a firearm-mounted accessory includes a body comprising clamping members to mount to a rail of a firearm, a tail cap attached to a rear side of the body, left-side and right-side axles held rotatably in the tail cap, left-side and right-side outer arms attached to the left-side and right-side axles, respectively, left-side and right-side inner arms within the tail cap and attached to the left-side and right-side axles, respectively, a printed circuit board (PCB) held in the tail cap above the left-side and right-side axles, and left-side and right-side button switches (pushbutton switches) coupled to the PCB, wherein when the left-side and right-side outer arms are pressed, the left-side and right-side inner arms are configured to press the left-side and right-side button switches, respectively.

The above and other features will be apparent from the following detailed discussion.

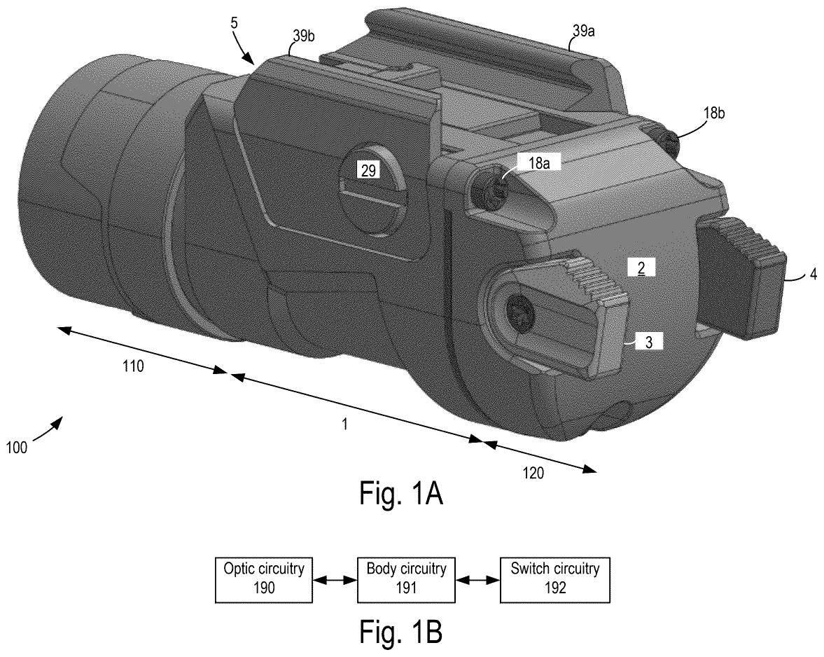

FIG. 1A depicts a side-rear view of a firearm-mounted light 100, including a light body 1 (light accessory body), an optic 110 at the front of the main body, and a tail section 120 at the rear of the light body, in accordance with various embodiments. This figure shows the whole firearm-mounted light 100 (the product or light accessory) and outer arms that get pressed down by a user to activate the light. The light accessory includes a body 1, an optic such as a lens attached to a front side of the body and a tail section 120 attached to a rear side of the body using screws 18a and 18b. The tail section includes a tail cap 2, a left-side outer arm 3 and a right-side outer arm 4 on an opposing side of the tail cap.

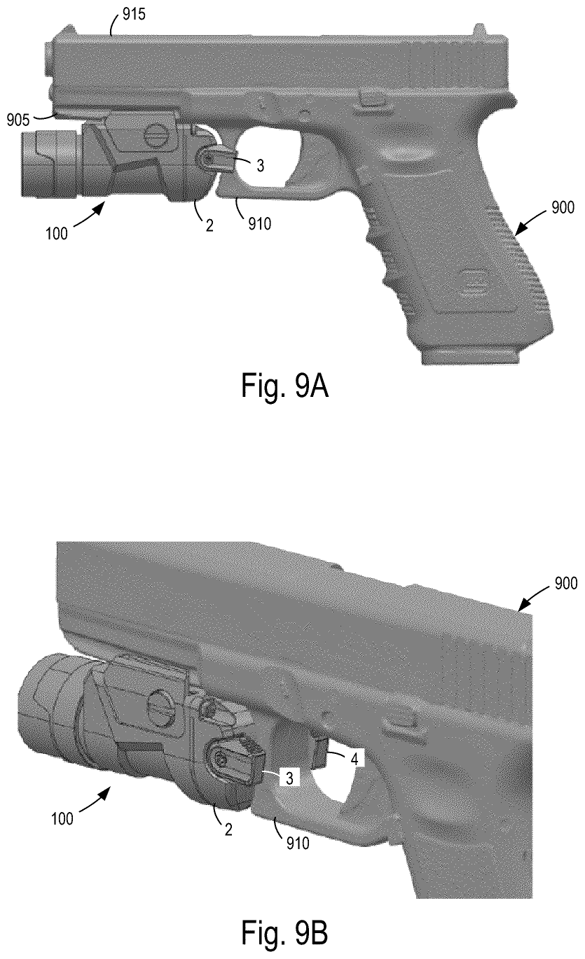

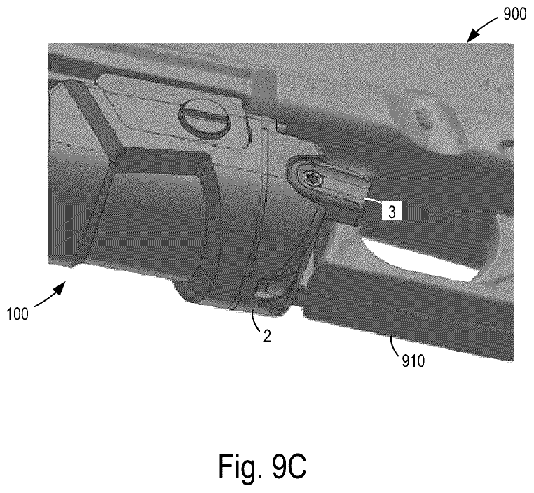

A top portion of the body is configured for mounting to a rail of a firearm such as a handgun. For example, the body can include opposing clamping members 39a and 39b to secure the light 100 to a rail. In one approach, the clamping member 39a is fixed to the body and the clamping member 39b is part of a rail clamp 5 which can be attached to the body and tightened using a thumb screw 29. When the rail clamp 5 is tightened, the clamping member 39b moves closer to the opposing clamping member 39a to tighten the body to the rail. See also FIG. 9A.

The arms 3 and 4 protruding from the tail cap of the light are used to turn the light on and off by pressing down on them. When the light is mounted to a pistol (see FIGS. 9A-9C), the trigger guard of the pistol sits in a gap between the arms, which allows for ambidextrous pointer finger control of the light.

Both arms can perform the same function and can be independently pressed, in one approach. In an example implementation, a quick press and release of an arm will turn the light on to a steady mode, while another quick press and release of an arm will turn the light off. A longer press and hold of an arm can turn the light on in a momentary mode, where the light will turn off when the arm is released.

FIG. 1B depicts an example block diagram of circuitry of the firearm-mounted light 100, in accordance with various embodiments. The circuitry includes optic circuitry 190 in the optic 110, body circuitry 191 in the body 1, and switch circuitry in the tail section 120. The optic circuitry 190 can include a light source such as an LED and electrical connections to the body circuitry. The body circuitry can include a power source such as one or more batteries, battery contacts and wiring. The body circuitry can also include a battery protection circuit, such as when Li-ion cells are used, to prevent over-charge, over-discharge, or short-circuit. In the case of an LED optic, the optic circuitry and/or the body circuitry can include an LED driver circuit. The body circuitry can include a mode control circuit such as for different brightness setting or a strobe light setting, protection circuits, charging circuits and indicator circuits. The switching circuitry can include switches, PCBs and electrical paths such as described herein to control the body circuitry.

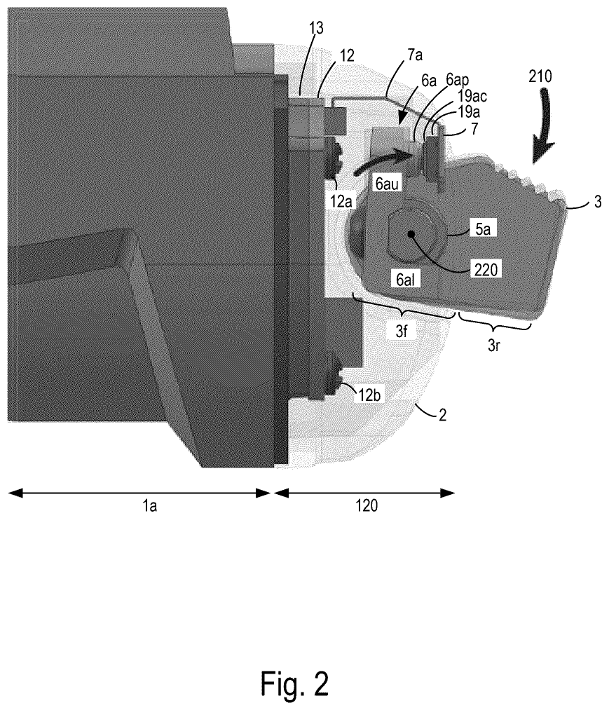

FIG. 2 depicts a cutaway cross-sectional view of the tail section 120 and a portion 1a of the body 1 of the firearm-mounted light 100 of FIG. 1A, in accordance with various embodiments. This figure shows the movement of the outer arms 3, 4 and how the movement gets transferred to the left-side and right-side inner arms 6a and 6b, respectively, which then make contact with left-side and right-side button switches 19a and 19b, respectively, on a button PCB 7.

An arrow 210 shows a direction in which the arm 3 can be pressed by the user. The arm is attached to an axle which can rotate about an axis 220, as indicated by the curved arrow, to cause an inner arm 6a to also rotate and contact a button 19a. The inner arm 6a includes a lower portion 6al attached to the outer arm 3 and an upper portion 6au which extends upward from the lower portion. The upper portion include a protrusion 6ap which extends rearward. The protrusion may have corresponding size and shape as a contact area 19ac of the button 19a. For example, the contact area and the protrusion may both be round and have a similar diameter, e.g., within +/10-20%. When the protrusion presses against the contact area, the contact area moves rearward within the button to close a circuit path. The right-side inner arm 6b may be configured similarly as the left-side inner arm 6a.

The button is attached to a button PCB 7 which includes circuitry for controlling the light. A flexible element of the PCB 7a extends forward from the PCB 7 to hold the PCB 7 to another PCB 12, in an example implementation. The button PCB 7 can communicate via wires or other conductive paths with the PCB 12 of the body. The PCB 12 in turn can communicate with components inside the body and the optic, such as a battery and light source, to control the light output.

The PCB 12 is attached to the light body 1 by a tail cap inner frame 13 and screws 12a and 12b.

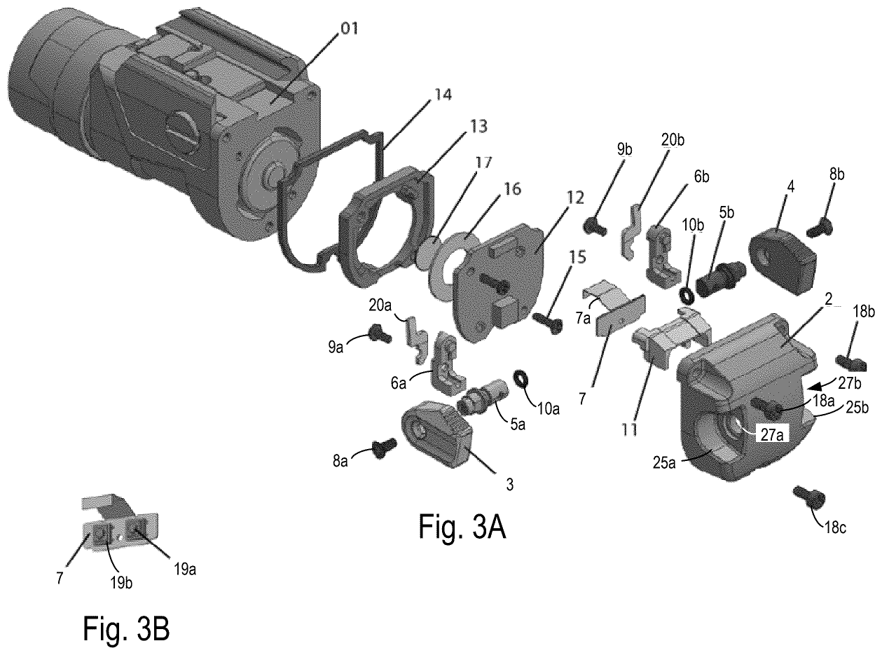

A front part 3f of the outer arm 3 extends in a recess 25a in the tail cap, and a rear part 3r of the outer arm 3 extends rearward of the recess and the tail cap. See also FIG. 3A.

FIG. 3A depicts an exploded view of the firearm-mounted light 100 of FIG. 1A, in accordance with various embodiments. A number of components are depicted including the light body 1, the tail cap cover 2, the left-side outer arm 3, the right-side outer arm 4, arm axles 5a and 5b, inner arms 6a and 6b, the button PCB 7, outer arm screws 8a and 8b, inner arm screws 9a and 9b, axle O-rings 10a and 10b, button standoff 11, PCB 12, tail cap inner frame 13, tail cap gasket 14, PCB screws 15 (2×), contact ring 16, contact disk 17, tail cap screws 18a, 18b and 18c, button switches 19a and 19b (FIG. 3B), and return springs 20a and 20b.

The PCB 12 is coupled to the battery by the contact disk 16, 17.

Note that the configuration of the return springs shown is one possible implementation, as other implementations are possible.

The tail cap can include left-side and right-side recesses or cutouts 25a and 25b, respectively, on opposing sides of the tail cap for the left-side and right-side outer arms 3 and 4, respectively. This provides a compact design and positions the outer arms adjacent to either side of the trigger guard of the firearm. As mentioned, a front part of the outer arms 3, 4 extends in the respective recess, and a rear part of the outer arms extends rearward of the respective recess. See also FIG. 2. The tail cap also includes left-side and right-side openings 27a and 27b, respectively, in which the arm axles 5a and 5b, respectively, are held. The arm axles can rotate within the openings as the outer arms are pressed and released. The arm axles are thus held rotatably in the openings of the tail cap.

FIG. 3B depicts a front side of the button printed circuit board (PCB) 7 of FIG. 3A, in accordance with various embodiments. Button switches 19a and 19b are attached to the PCB 7. When the outer arms 3 or 4 are pressed down, the inner arms 6a or 6b, respectively, rotate to press the button switches 19a or 19b, respectively, closing a respective electrical circuit in the PCB 7. When a button switch is pressed, it may move slightly to touch a contact to thereby closes an electric circuit. This in turn causes the PCB 7 to control the light source in the body, such as turning the light source on or off or controlling a mode of the light source.

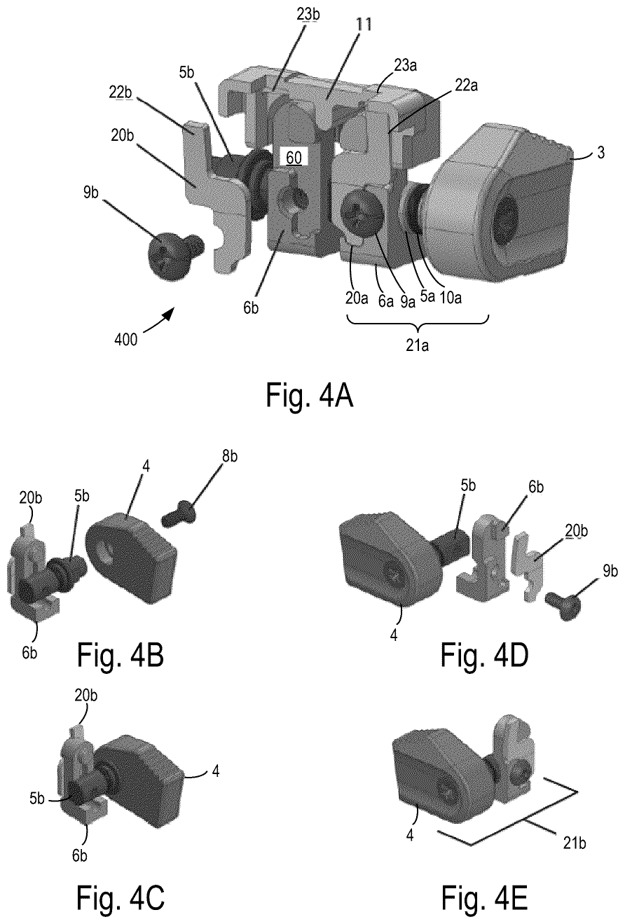

FIG. 4A shows how the return springs 20a, 20b operate. Each return spring sits in a relief (see, e.g., the return spring 20b and the relief 60 in FIG. 4A) within the inner arm 6a, 6b and is secured with the inner arm screw 9a, 9b. The tip 22a, 22b (FIG. 4A) of the return spring rests against a ledge 23a, 23b on the button switch standoff 11 with some preloaded tension. When the outer arm 3, 4 is pressed down, the arm assembly 21a, 21b (FIGS. 4A and 4C) rotates, which applies more tension in the return spring 20a, 20b against the button switches 19a, 19b in the button switch standoff 11. When the outer arm 3, 4 is released, the return spring 20a, 20b will rotate the arm assembly 21a, 21b back to its resting position.

In an example implementation, when a respective one of the outer arms 3, 4 is pressed down, a respective one of the inner arms 6a 6b rotates, which applies more tension in a respective one of the return springs 20a, 20b against a respective one of the button switches 19a, 19b in the button switch standoff, and when the respective one of the outer arms is released, the respective one of the return springs is to rotate the respective one of the inner arms back to a resting position.

FIG. 4A depicts a cutaway view of a portion of a switch assembly 400 in the tail section 120 of the firearm-mounted light 100 of FIG. 1A, including the left-side outer arm 3, in accordance with various embodiments. The view depicts the inner arms 6a and 6b positioned in the button switch standoff 11, which includes ledges 23a and 23b. The rotatable left-side arm assembly 21a is also depicted.

FIG. 4B depicts an exploded side-rear view of a portion of the switch assembly 400 of FIG. 4A with the right-side outer arm 4, in accordance with various embodiments.

FIG. 4C depicts a collapsed view of the portion of the switch assembly 400 of FIG. 4B, in accordance with various embodiments.

FIG. 4D depicts an exploded side-front view of a portion of the switch assembly 400 of FIG. 4A with the right-side outer arm 4, in accordance with various embodiments.

FIG. 4E depicts a collapsed view of the portion of the switch assembly 400 of FIG. 4D, in accordance with various embodiments.

FIGS. 4D and 4E show how the inner arm 6b attaches to the arm axle 5b to form the right-side arm assembly 21b. A flat surface is in contact between these parts to prevent rotation between them.

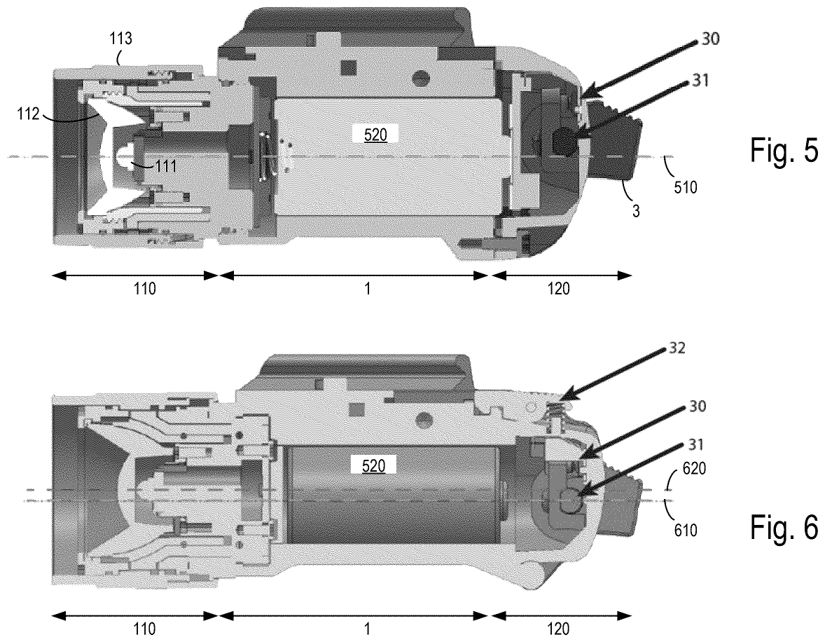

FIG. 5 depicts a cross-sectional view of an embodiment of the firearm-mounted light 100 of FIG. 1A in which an axle 31 and a button switch 30 of the switch assembly are both on one side of a centerline 510 of the light, in accordance with various embodiments. The optic 110 can include a light source 111 and a lens 112 housed within an outer collar 113. The optic can optionally be adjustable between a flood beam and a spot beam. The light source is powered by a battery 520 within the body 1 of the light. A closed circuit between the battery and the light source can be formed based on the position of the outer arms 3 and 4. In different applications, the button switch or the axle can be located differently in relation to the centerline of the firearm-mounted light 100. In this example, the axle 31 and the button switch 30 are located above the centerline.

FIG. 6 depicts a cross-sectional view of an embodiment of the firearm-mounted light 100 of FIG. 1A in which an axle 31 is sitting in-line with the centerline 610 of the battery 520 but below the centerline 620 of the light.

In this example, a latch 32 is added to the tail cap assembly to allow the tail cap to open to allow the user to remove and insert one or more batteries. Because of the space required for the latch, the switch assembly is pushed down lower in the light accessory to a point where the axle 31 is sitting in-line with the centerline 610 of the battery but below the centerline 610 of the light 100. The button switch 30 is above both the centerline 510 of the battery and the centerline 620 of the light accessory.

Note also in this example that the button switches 19a, 19b are mounted on the rear surface of the inside of the product and facing forward. This means the downward pressure of the outer arm transfers forces rearward towards the button switch.

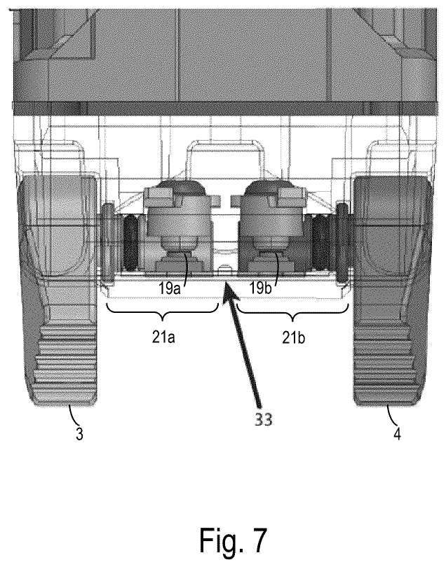

FIG. 7 depicts a top cutaway view of the switch assembly of the firearm-mounted light 100 of FIG. 1A, in accordance with various embodiments. This figure shows the gap 33 between the right-side arm assembly 21b and the left-side arm assembly 21a. This means either arm can be actuated independently without the other arm assembly rotating. Both button switches 19a, 19b are connected to the same circuit, so both sides function the same and complete the same circuit, in one possible implementation. In another possible implementation, the different button switches are coupled to different circuits which provide different lighting functions when the associated outer arm is pressed. For example, one button switch and respective arm may provide a low intensity light while the other button switch and respective arm provide a high intensity light. Or, one button switch and respective arm may provide a steady light while the other button switch and respective arm provide a strobe light. Or, one button switch and respective arm may be pressed and held down while the other button switch and respective arm may be pressed one or more times to cycle through mode settings.

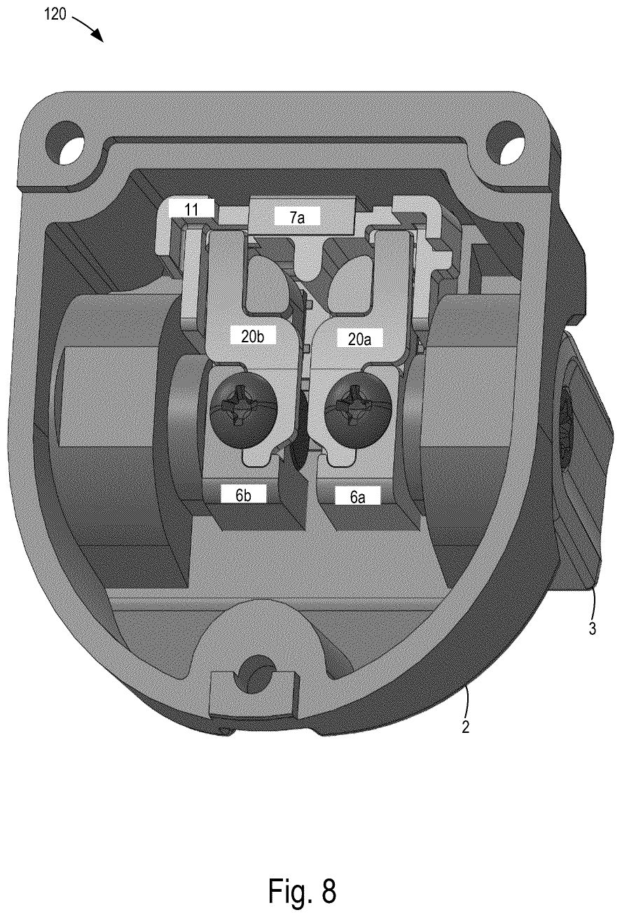

FIG. 8 depicts a rearward-facing cutaway view of the tail section 120 of the firearm-mounted light 100 of FIG. 1A, in accordance with various embodiments. This figure depicts the tail cap cover 2, the left-side outer arm 3, the inner arms 6a and 6b, the return springs 20a and 20b, the bracket 7a and the button switch standoff 11.

FIG. 9A depicts a side view of the firearm-mounted light 100 of FIG. 1A attached to an example firearm 900, in accordance with various embodiments. The firearm 900 includes a rail 905 to allow mounting of the light 100 under the barrel 915 of the firearm. The rail is at an underside of the barrel. The outer arms are positioned on either side of the front part of a trigger guard 910.

FIG. 9B depicts a closeup side-rear view of the firearm 900 and firearm-mounted light 100 of FIG. 9A, in accordance with various embodiments. This figure shows both the left-side outer arm 3 adjacent to the left side of the trigger guard 910 and the right-side outer arm 4 adjacent to the right side of the trigger guard.

FIG. 9C depicts a closeup side-bottom view of the switch arm 3 and the trigger guard 910 of the firearm 900, in accordance with various embodiments.

FIGS. 9A-9C show some additional views of how the light mounts to a pistol, and how the outer arms extend past the trigger guard to allow easier actuation with the user's pointer finger.

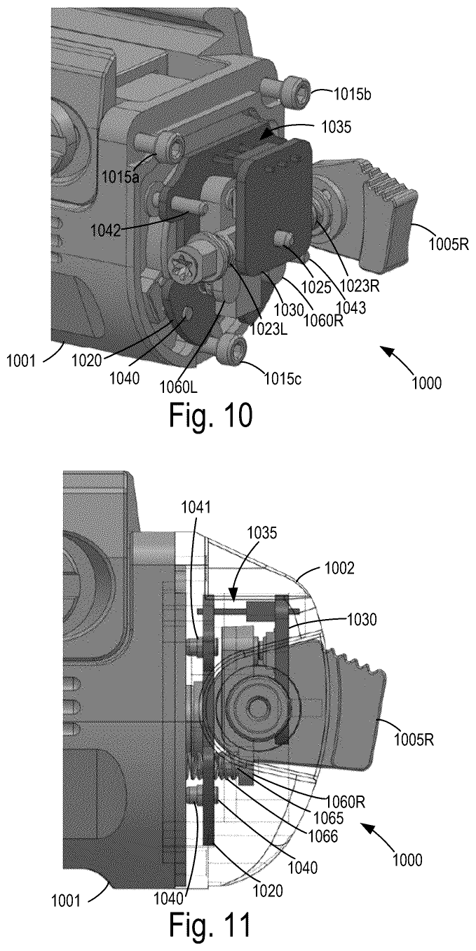

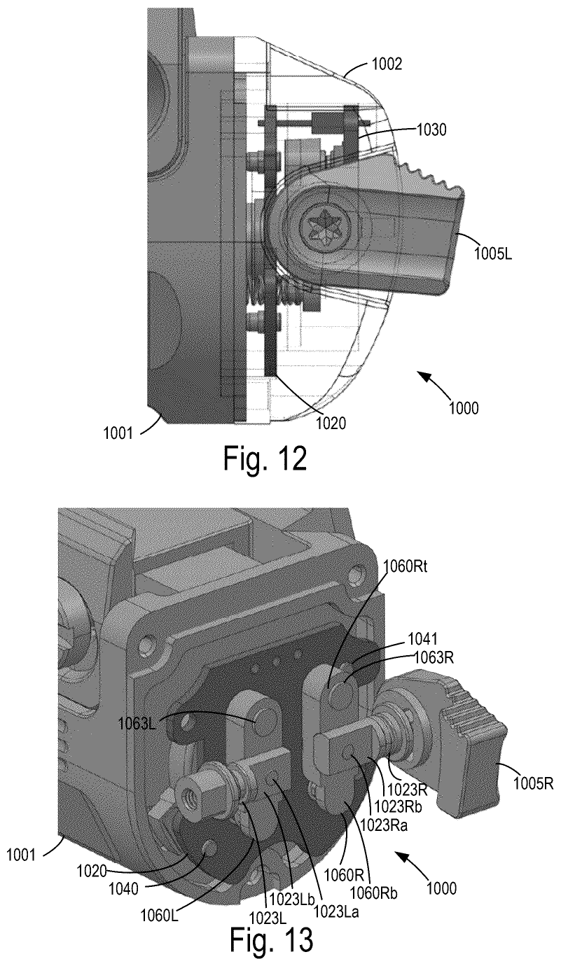

FIG. 10 depicts a cutaway view of a portion of another switch assembly 1000 in a tail section of a firearm-mounted light, including a right-side outer arm 1005R, and left-side and right-side inner arms 1060L and 1060R, respectively, in accordance with various embodiments. A left-side outer arm 1005L (FIG. 12) can also be provided. The left-side and right-side outer arms can be independently pressed to cause the left-side and right-side inner arms, respectively, to press respective button switches. When one of the outer arms is pressed, it causes a respective axle to rotate. A respective inner arm is attached to the respective axle such that the inner arm rotates over a small arc such as less than 45 degrees. For example, the left-side inner arm 1060L is attached to the left-side axle 1023L, and the right-side inner arm 1060R is attached to the right-side axle 1023R.

In an example implementation, a top portion of the inner arm rotates and moves rearward toward a respective button switch attached to a front-facing side of a PCB 1030, thereby pressing and activating the button switch. For example, see the top and bottom portions 1060Rt and 1060Rb, respectively, of the inner arm 1060R in FIG. 13.

Each inner arm may be spring biased to prevent activation of the button switch unless the respective outer arm is pressed. For example, see the spring 1066 in FIG. 11 at the bottom portion 1060Rb of the inner arm 1060R. The PCB 1030 may be electrically coupled to an additional PCB 1020 by one or more pins 1035 to provide electrical signals to the light assembly body when a button switch is activated, thereby controlling the optic of the light assembly. The additional PCB 1020 is electrically coupled to the light assembly body

A tail cap may be attached to the body light assembly body 1001 by screws 1015a, 1015b and 1015c. The PCB 1020 is attached to the rear of the body by electrical contact pins 1040 and 1041 (FIG. 11) and mechanical pins 1042 and 1043. The PCB 1030 may be attached to the tail cap 1002 by a screw 1025. The head of the screw is on the front side of the PCB 1030. During assembly, the rearmost PCB 1030 is screwed into the tail cap with the screw or pin 1025. The switch arms are then installed, and the additional PCB 1020 is placed on top of the assembly and screwed in place to the light assembly body 1001. The three header pins 1035 are soldered to connect the boards, and the tail cap is assembled onto the light body by the screws 1015a-c.

FIG. 11 depicts a side view of the switch assembly 1000, including the right-side outer arm 1005R, within a tail cap 1002, in accordance with various embodiments. The spring biasing of the inner arm 1060R is provided by a frontward-protruding pin 1065 of the inner arm which mates with a spring 1066. The right-side outer arm 1005R is depicted in this view, along with the pins 1035, PCBs 1020 and 1030, and electrical contact pins 1040 and 1041, which provide electrical connections between the PCB 1020 and circuits within the light assembly body 1001 for controlling the optic.

FIG. 12 depicts a side view of the switch assembly 1000, including the left-side outer arm 1005L, in accordance with various embodiments. The PCBs 1020 and 1030 are also shown.

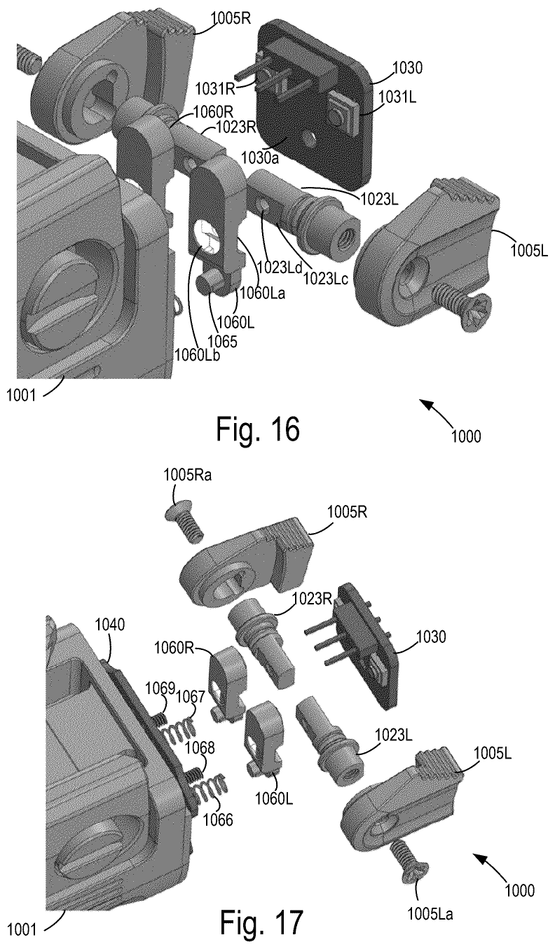

FIG. 13 depicts a view of the switch assembly 1000, including further detail of the left-side and right-side inner arms 1060L and 1060R, respectively, in accordance with various embodiments. The left-side and right-side inner arms 1060L and 1060R, respectively, each include a rear-facing protrusion 1063L and 1063R, respectively, which is configured to press a respective contact switch on the PCB 1030, when the respective outer arm is pressed. For example, see the contact switches 1031L and 1031R in FIG. 16. In this example, the protrusions are on a top portion (e.g., 1060Rt) of the inner arms.

Each inner arm 1060L and 1060R may be attached to a respective axle 1023L and 1023R by a respective pin 1023La and 1023Ra. Each axle 1023L and 1023R may have a rear-facing flat surface region 1023Lb and 1023Rb, respectively, adjacent to the PCB 1030 to allow the PCB 1030 to be placed closer to the light assembly body 1001 for compactness.

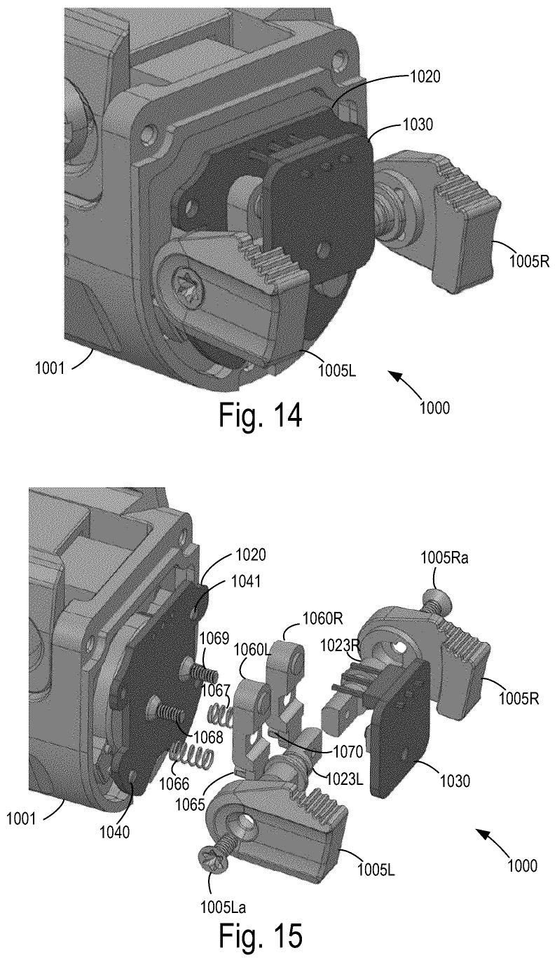

FIG. 14 depicts a view of the switch assembly 1000, including the left-side and right-side outer arms 1005L and 1005R, respectively, in accordance with various embodiments. The PCBs 1020 and 1030 are also depicted.

FIG. 15 depicts an exploded top-rear view of the switch assembly 1000, in accordance with various embodiments. The left-side outer arm 1005L is attached to the left-side axle 1023L by a screw 1005La, and the right-side outer arm 1005R is attached to the right-side axle 1023R by a screw 1005Ra. The left-side inner arm 1060L is attached to the left-side axle 1023L by a screw 1068, and the right-side inner arm 1060R is attached to the right-side axle 1023R by a screw 1069. The springs 1066 and 1067 can mate with frontward-protruding pins 1065 and 1070, respectively, of the inner arms 1060L and 1060R, respectively, to bias the left-side and right-side inner arms away from the contact switches.

FIG. 16 depicts an exploded top-front view of the switch assembly 1000, in accordance with various embodiments. Each inner arm may include an opening, e.g., 1060Lb, to allow a screw, e.g., 1068 to pass through, to attach to a threaded opening, e.g., 1023Ld of a respective inner arm, e.g., 1023L. This allows the inner arm to be secured to the axle. Additionally, the inner arm may have a cutout region, e.g., 1060La which mates with a front-facing flat surface, e.g., 1023Lc of a respective inner arm, e.g., 1023L. This provides a compact configuration which facilitates the attaching of the inner arm to the axle.

The pushbutton switches 1031L and 1031R are depicted as being attached to the front-facing side 1030a of the PCB 1030.

FIG. 17 depicts an exploded top view of the switch assembly 1000, in accordance with various embodiments.

Note that while the examples herein provide left-side and right-side outer arms on opposing sides of the tail cap, it is possible to provide the outer arm on just one side.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A firearm-mounted accessory, comprising:
a body comprising clamping members to mount to a rail of a firearm;
a tail cap attached to a rear side of the body;
left-side and right-side axles held rotatably in the tail cap;
left-side and right-side outer arms attached to the left-side and right-side axles, respectively;
left-side and right-side inner arms within the tail cap and attached to the left-side and right-side axles, respectively;
a printed circuit board (PCB) within in the tail cap; and
left-side and right-side button switches coupled to the PCB, wherein based on pressing of the left-side and right-side outer arms, the left-side and right-side inner arms are configured to press the left-side and right-side button switches, respectively.

2. The firearm-mounted accessory of claim 1, further comprising:
a battery within the body; and
an optic including a light source attached to a front side of the body.

3. The firearm-mounted accessory of claim 1, wherein the firearm is a handgun and the rail is at an underside of a barrel of the handgun.

4. The firearm-mounted accessory of claim 1, wherein:
the tail cap comprises left-side and right-side recesses;
a front part of the left-side and right-side outer arms extends in the left-side and right-side recesses, respectively; and
a rear part of the left-side and right-side outer arms extends rearward of the left-side and right-side recesses, respectively.

5. The firearm-mounted accessory of claim 1, wherein the left-side and right-side inner each arms each comprises a protrusion configured to press the left-side and right-side button switches based on pressing of the left-side and right-side outer arms, respectively.

6. The firearm-mounted accessory of claim 5, wherein the protrusions have a corresponding size and shape as the left-side and right-side button switches.

7. The firearm-mounted accessory of claim 1, further comprising:
an element to hold the PCB; and
an additional PCB attached to the element and to an inner frame of the tail cap.

8. The firearm-mounted accessory of claim 1, further comprising a button switch standoff in which the PCB is housed.

9. The firearm-mounted accessory of claim 1, further comprising left-side and right-side springs coupled to the left-side and right-side inner arms, respectively.

10. The firearm-mounted accessory of claim 9, further comprising a button switch standoff in which the PCB is housed, wherein tips of the springs rest against respective ledges on the button switch standoff with a preloaded tension.

11. The firearm-mounted accessory of claim 9, wherein:
based on a respective one of the outer arms being pressed down, a respective one of the inner arms rotates, to apply more tension in a respective one of the springs against a respective one of the button switches; and
based on the respective one of the outer arms being released, the respective one of the return springs is to rotate the respective one of the inner arms back to a resting position.

12. The firearm-mounted accessory of claim 1, wherein:
the PCB is a first PCB;
the firearm-mounted accessory further comprises a second PCB electrically coupled to circuitry in the body; and
the first PCB comprises one or more pins to electrically couple to the second PCB.

13. The firearm-mounted accessory of claim 1, wherein each of the left-side and right-side axles comprises a respective front-facing flat surface configured to mate with a respective cutout region of the left-side and right-side inner arms.

14. The firearm-mounted accessory of claim 1, wherein each of the left-side and right-side axles comprises a respective rear-facing flat surface adjacent to the PCB.

15. The firearm-mounted accessory of claim 1, wherein each of the left-side and right-side inner arms comprises a respective frontward-protruding pin configured to mate with a respective spring.

16. A firearm-mounted accessory, comprising:
a body comprising clamping members to mount to a rail of a firearm;
a tail cap attached to a rear side of the body;
an axle held rotatably in the tail cap;
an outer arm attached to the axle;
an inner arm within the tail cap and attached to the axle;
a printed circuit board (PCB) within in the tail cap; and
a button switch coupled to the PCB, wherein based on rotation of the outer arm, the inner arm is configured to rotate and press the button switch.

17. The firearm-mounted accessory of claim 16, further comprising a spring to bias the inner arm away from the button switch.

18. The firearm-mounted accessory of claim 16, wherein the inner arm is configured to rotate about the axle.

19. The firearm-mounted accessory of claim 16, wherein:
the PCB is a first PCB;
the firearm-mounted accessory further comprises a second PCB electrically coupled to circuitry in the body; and
the first PCB comprises one or more pins to electrically couple to the second PCB.

20. The firearm-mounted accessory of claim 16, wherein the axle comprises a front-facing flat surface configured to mate with a rear-facing cutout region of the inner arm.
